(19) United States
(12) Patent Application Publication
(10) Pub. No.: US 2008/0104743 A1
(43) Pub. Date: May 8, 2008

(54) Heat-resistant panels

(76) Inventor: Ray Ng, Littleton, CO (US)

Correspondence Address: Powley & Gibson, P.C., 304 Hudson Street, 2nd Floor, New York, NY, 10013, US

(21) Appl. No.: 11/824,716

(22) Filed: Jun. 30, 2007

Related U.S. Application Data
(63) Continuation-in-part of application No. 11/726,944, filed on Mar. 23, 2007.
Application No. 11/726,944 is a continuation-in-part of application No. 11/592,763, filed on Nov. 3, 2006.
(60) Provisional application No. 60/901,928, filed on Feb. 15, 2007.

(51) Int. Cl. A62B 17/00

(52) U.S. Cl. 2/458

(57) ABSTRACT

A heat-resistant panel that protects a person from heat generated by an engine or an exhaust of a motorcycle, snowmobile, all-terrain vehicle or other conveyance or vehicle having an engine and exhaust, and a method of blocking heat from an engine or an exhaust to protect a person from heat by placing a heat-resistant panel between the person and the engine or exhaust. The heat-resistant panel may be dimensioned to cover wholly or partially the person's leg area, knee area, ankle area, seat area or crotch area. The heat-resistant panel may be made of thermal insulating and thermal reflecting materials and may provide heat resistance of from about 80% to about 100%. The heat resistant panel may have thickness of from about 0.25 inches to about 0.75 inches. The heat-resistant panel may be worn by the person alone or as an undergarment or outergarment. The heat-resistant panel may be secured to a person's body or clothing. using straps, hook fasteners, loop fasteners, buckles, snaps, buttons, button holes and the like. The heat-resistant panel may also be sewn, glued or otherwise non-releasably secured to clothing.

### CROSS-REFERENCE TO RELATED APPLICATIONS

This application is a continuation-in-part of earlier filed application Ser. No. 11/726,944, filed on Mar. 23, 2007 by the present inventor, which is a continuation-in-part of earlier filed application Ser. No. 11/592,763, filed on Nov. 3, 2006 by the present inventor, the disclosures of which are hereby incorporated by reference in their entirety. This application further claims the benefit of provisional application Ser. No. 60/901,928, filed on Feb. 15, 2007 by the present inventor, the disclosure of which is hereby incorporated by reference in its entirety.

### BACKGROUND

(a) Field of the Invention

This invention relates to panels that protect a person's body from heat, as produced, for example, by motorcycles, snowmobiles, all-terrain vehicles or any other conveyance or vehicle having an engine and exhaust.

(b) Discussion of the Related Art

People operating motorcycles, snowmobiles, all-terrain vehicles or other conveyances or vehicles having an engine and exhaust may experience discomfort and injury resulting from inadequate protection against heat generated by the engine and exhaust. Information relevant to protective garments may be found in U.S. Pat. Nos. 5,210,877; 4,035,844; 4,280,342; 5,087,499; 6,083,857 and 5,660,914. However, none of these references resolves the problem of discomfort or injury from engine and exhaust heat.

For the foregoing reasons, there is a need for clothing that provides sufficient heat-resistance to protect people from engine and exhaust heat.

### SUMMARY

An object of this invention is a heat-resistant panel.

Some embodiments provide a heat-resistant panel placed between a person and an engine or an exhaust of a motorcycle, snowmobile, all-terrain vehicle or other motorized conveyance or vehicle having an engine and exhaust to block heat from the engine or exhaust.

Some embodiments provide a heat-resistant panel that may be worn by a person alone or as an undergarment or outergarment.

Some embodiments provide a heat-resistant panel dimensioned to cover a leg area of a person.

Some embodiments provide a heat-resistant panel dimensioned to cover an upper leg area of a person.

Some embodiments provide a heat-resistant panel dimensioned to cover a lower leg area of a person.

Some embodiments provide a heat-resistant panel dimensioned to cover a knee area of a person.

Some embodiments provide a heat-resistant panel dimensioned to cover an ankle area of a person.

Some embodiments provide a heat-resistant panel dimensioned to cover a seat area of a person.

Some embodiments provide a heat-resistant panel dimensioned to cover any combination of a seat area, a leg area and a crotch area of a person.

Some embodiments provide a heat-resistant panel comprising thermal insulating material.

Some embodiments provide a heat-resistant panel comprising one or more thermal insulating materials selected from the group consisting of polypropylene, polyester fibers, polyphenylene sulfide fibers, oxidized polyacrylonitrile fibers, meta-aramid fibers, para-aramid fibers, polytetrafluoroethylene fibers, polyimide fibers, polyparaphenylenebenzobisoxazole fibers, carbon fibers, glass fibers, metallic fibers, polybenzimidazole fibers, modacrilic fibers, polyvinyl halide fibers, wool fibers, nylon fibers, rayon fibers, cotton fibers, ceramic wool fibers, melamine foam, urethane foam, rubber, polyethylene foam, polychloroprene, polyester foam, polyether polyurethane foam and polyethylene terephthalate film.

Some embodiments provide a heat-resistant panel comprising polyester fibers needlepunched through a nonwoven substrate and through a reflective polyethylene terephthalate film.

Some embodiments provide a heat-resistant panel providing heat resistance of from about 80% to about 100%.

Some embodiments provide a heat-resistant panel providing heat resistance of from about 85% to about 92%.

Some embodiments provide a heat-resistant panel providing heat resistance of from about 80% to about 100% after exposure to heat generated by a motorcycle engine continuously in operation for about 10 minutes.

Some embodiments provide a heat-resistant panel providing heat resistance of from about 85% to about 92% after exposure to heat generated by a motorcycle engine continuously in operation for about 10 minutes.

Some embodiments provide a heat-resistant panel having thickness of from about 0.25 inches to about 0.75 inches.

Some embodiments provide a heat-resistant panel secured to a person.

Some embodiments provide a heat-resistant panel releasably secured to a person.

Some embodiments provide a heat-resistant panel secured to clothing.

Some embodiments provide a heat-resistant panel releasably secured to clothing.

Some embodiments provide a heat-resistant panel with straps, bands, belts, harnesses, leashes, strops, ties, bindings, cords, braided materials, hook fasteners, loop fasteners, buckles, clamps, clasps, clips, snaps, cinches, buttons or any other suitable article or material attached to the heat-resistant panel, wherein the article or material is useful for securing the heat-resistant panel to a person or to clothing.

Some embodiments provide a heat-resistant panel with button holes, eyelets or any other suitable opening useful for securing the heat-resistant panel to a person or to clothing, wherein the button holes or eyelets may be reinforced with thread, grommets or any other suitable article or material.

Some embodiments provide a heat-resistant panel having an upper edge, a first side edge, a second side edge, a lower edge, an anterior surface and a posterior surface.

Some embodiments provide a first strap, wherein the first strap is a continuous loop and wherein a portion of the first strap less than its total circumference is attached to an anterior surface or a posterior surface of a heat-resistant panel.

Some embodiments provide a first strap, wherein a first end of the first strap is attached to a first side edge, an anterior surface or a posterior surface of a heat-resistant panel and wherein a second end of the first strap is attached to a second side edge, an anterior surface or a posterior surface of the heat-resistant panel.

Some embodiments provide a first strap, a first buckle, a second buckle, a third buckle and a fourth buckle, wherein a first buckle is attached to a first end of the first strap, wherein a second buckle is attached to a second end of the first strap, wherein a third buckle is attached to a first side edge, an anterior surface or a posterior surface of a heat-resistant panel, wherein a fourth buckle is attached to a second side edge, an anterior surface or a posterior surface of the heat-resistant panel and wherein the first buckle is mated to the third buckle and the second buckle is mated to the fourth buckle.

Some embodiments provide a first strap and a second strap, wherein a first end of the first strap is attached to a first side edge, an anterior surface or a posterior surface of a heat-resistant panel and wherein a first end of the second strap is attached to a second side edge, an anterior surface or a posterior surface of the heat-resistant panel.

Some embodiments provide a first strap and a second strap, wherein a first end of the first strap is attached to a first side edge, an anterior surface or a posterior surface of a heat-resistant panel, wherein a first end of the second strap is attached to a second side edge, an anterior surface or a posterior surface of the heat-resistant panel, wherein hook fasteners are attached to a second end of the first strap and wherein loop fasteners are attached to a second end of the second strap.

Some embodiments provide a first strap and a second strap, wherein a first end of the first strap is attached to a first side edge, an anterior surface or a posterior surface of a heat-resistant panel, wherein a first end of the second strap is attached to a second side edge, an anterior surface or a posterior surface of the heat-resistant panel and wherein buckles are attached to a second end of the first strap and a second end of the second strap.

Some embodiments provide a first strap and a second strap, wherein a first end of the first strap is attached to a first side edge, an anterior surface or a posterior surface of a heat-resistant panel, wherein a first end of the second strap is attached to a second side edge, an anterior surface or a posterior surface of the heat-resistant panel and wherein snaps are attached to a second end of the first strap and a second end of the second strap.

Some embodiments provide a first strap and a second strap, wherein a first end of the first strap is attached to a first side edge, an anterior surface or a posterior surface of a heat-resistant panel, wherein a first end of the second strap is attached to a second side edge, an anterior surface or a posterior surface of the heat-resistant panel and wherein a button is attached to a second end of the first strap and wherein a button hole is present in a second end of the second strap.

Some embodiments provide a first strap and a first buckle, wherein a first end of the first strap is attached to a first side edge, an anterior surface or a posterior surface of a heat-resistant panel, wherein the first buckle is attached to a second side edge, an anterior surface or a posterior surface of the heat-resistant panel and wherein a second end of the first strap is received through the first buckle.

Some embodiments provide a first strap and a first buckle, wherein a first end of the first strap is attached to a first side edge, an anterior surface or a posterior surface of a heat-resistant panel, wherein the first buckle is attached to a second side edge, an anterior surface or a posterior surface of the heat-resistant panel, wherein a second end of the first strap is received through the first buckle and wherein hook fasteners and loop fasteners are attached to the first strap.

Some embodiments provide a first strap, wherein a first end of the first strap is attached to a first side edge, an anterior surface or a posterior surface of a heat-resistant panel, wherein hook fasteners are attached to a second end of the first strap and wherein loop fasteners are attached to a second side edge, an anterior surface or a posterior surface of the heat-resistant panel.

Some embodiments provide a first strap, wherein a first end of the first strap is attached to a first side edge, an anterior surface or a posterior surface of a heat-resistant panel, wherein loop fasteners are attached to a second end of the first strap and wherein hook fasteners are attached to a second side edge, an anterior surface or a posterior surface of the heat-resistant panel.

Some embodiments provide a first strap, wherein a first end of the first strap is attached to a first side edge, an anterior surface or a posterior surface of a heat-resistant panel and wherein buckles are attached to a second end of the first strap and a second side edge, an anterior surface or a posterior surface of the heat-resistant panel.

Some embodiments provide a first strap, wherein a first end of the first strap is attached to a first side edge, an anterior surface or a posterior surface of a heat-resistant panel and wherein snaps are attached to a second end of the first strap and a second side edge, an anterior surface or a posterior surface of the heat-resistant panel.

Some embodiments provide a first strap, wherein a first end of the first strap is attached to a first side edge, an anterior surface or a posterior surface of a heat-resistant panel, wherein a button hole is present in a second end of the first strap and wherein a button is attached to a second side edge, an anterior surface or a posterior surface of the heat-resistant panel.

Some embodiments provide a first strap, wherein a first end of the first strap is attached to a first side edge, an anterior surface or a posterior surface of a heat-resistant panel, wherein a button is attached to a second end of the first strap and wherein a button hole is present in the heat-resistant panel adjacent to a second side edge of the heat-resistant panel.

Some embodiments provide a first strap and a second strap, wherein a first end of the first strap is attached to a first side edge, an anterior surface or a posterior surface of the heat-resistant panel, wherein hook fasteners, loop fasteners, a buckle, a snap or a button is attached to a second end of the first strap or a button hole is present in the second end of the first strap, wherein a first end of the second strap is attached to the second side edge of the heat-resistant panel and wherein hook fasteners, loop fasteners, a buckle, a snap or a button is attached to a second end of the second strap or a button hole is present in the second end of the second strap.

Some embodiments provide a heat-resistant panel sewn or stitched to clothing.

Some embodiments provide a heat-resistant panel secured to clothing with an adhesive.

Another object of this invention is a method of blocking heat from an engine or an exhaust of a motorcycle, snowmobile, all-terrain vehicle or other motorized conveyance or vehicle having an engine and exhaust comprising placing a heat-resistant panel as disclosed in any of the embodiments discussed herein between a person and the engine or exhaust.

### BRIEF DESCRIPTION OF THE DRAWINGS

These and other features, aspects and advantages of the present invention will become better understood with regard to the following description, appended claims and accompanying drawings where:

FIG. 1 shows a partial sectional perspective view of a person riding a motorcycle and wearing pants with a heat-resistant panel non-releasably secured to the pants.

FIG. 2 shows a front view of a pair of individual heat-resistant panels.

FIG. 3 shows a front view of a pair of individual heat-resistant panels and motorcycle chaps.

FIG. 4 shows a partial sectional front view of a person wearing motorcycle chaps wherein a pair of heat-resistant panels is releasably secured to inside surfaces of the motorcycle chaps.

FIG. 5 shows a perspective view of shorts wherein a heat-resistant panel is non-releasably secured to the shorts.

FIG. 6 shows a perspective view of undergarment pants wherein heat-resistant panels are non-releasably secured to the undergarment pants.

FIG. 7 shows a front view of the lower body of a person wherein heat-resistant panels cover the person's knee area and ankle area.

FIG. 8 shows a perspective view of a heat-resistant panel.

FIG. 9 shows a rear view of the lower body of a person wherein a heat-resistant panel covers the person's seat area.

FIG. 10 shows a side view of a heat-resistant panel.

### DETAILED DESCRIPTION OF EMBODIMENTS

The following description and examples illustrate some exemplary embodiments of the disclosed invention in detail. Those of skill in the art will recognize that there are numerous variations and modifications of this invention that are encompassed by its scope. Accordingly, the description of a certain exemplary embodiment should not be deemed to limit the scope of the present invention.

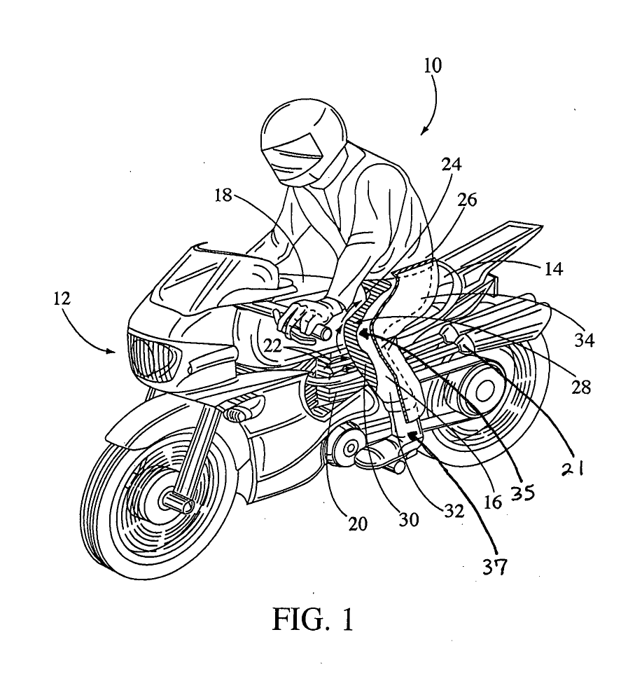

In FIG. 1, a partial sectional perspective view of a person, having a general reference numeral 10, riding a motorcycle, having a general reference numeral 12, is presented. The person 10 is shown sitting on top of a seat 14 with his or her legs 16 shown disposed next to a fuel tank 18, engine 20 and exhaust 21. Only one leg 16 of the person 10 is shown in the drawing. Arrows 22 are shown to depict heat from the engine 20 circulated around the person's lower body 26, and specifically the person's legs 16 and crotch area 24.

In this drawing, the person 10 is shown wearing pants 28 including a heat-resistant panel 30 and a pants member 32, wherein the heat-resistant panel 30 is non-releasably secured to the pants member 32. The heat-resistant panel 30 may be mounted and sewn, glued or otherwise similarly fastened on an outside surface or inside surface of the pants member 32 or stitched along the sides of the pants member 32. The pants 28 are worn by the person 10 as an undergarment and are shown disposed under pants 34. The pants 34 are made of an abrasion and tear-resistant material. A portion of the pants 34 has been cutaway to illustrate the pants 28. Also, the pants member 32 and the heat-resistant panel 30 may be made of abrasion-resistant material, and the pants 28 may be worn as outergarment pants.

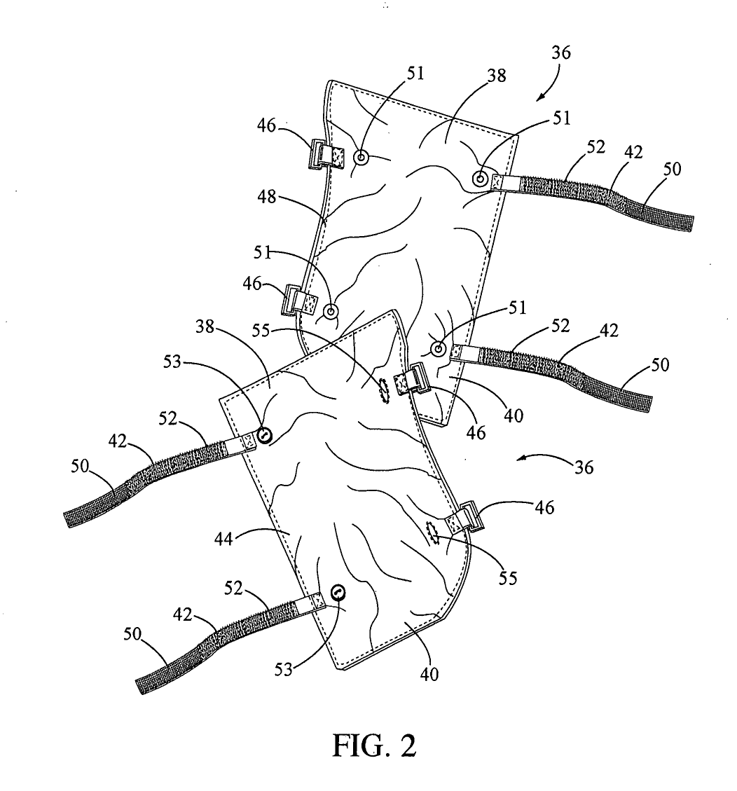

In FIG. 2, a front view of a pair of individual heat-resistant panels, having a general reference numeral 36, is presented. The heat-resistant panels 36 may be worn, for example, by a person 10 operating a motorcycle 12 for protection of the legs 16 from heat generated by the engine 20 and exhaust 21 of the motorcycle 12. Each of the heat-resistant panels 36 may be manufactured in different sizes and shapes. Each of the heat-resistant panels 36 may be dimensioned to cover wholly or partially an upper area of the leg 16, extending from the crotch area 24 to the knee area 35. Each of the heat-resistant panels 36 may also be dimensioned to cover wholly or partially a lower area of the leg 16, extending from the knee area 35 to the ankle area 37.

In this drawing, each of the heat-resistant panels 36 includes an upper portion 38 and lower portion 40. Two straps 42 are spaced apart and attached along a first side edge 44 of each of the heat-resistant panels 36. A pair of buckles 46 are spaced apart and attached along a second side edge 48 of each of the heat-resistant panels 36. Hook fasteners 50 and loop fasteners 52 are attached to the straps 42. The straps 42 may be disposed around the leg 16 and threaded through the buckles 46, and thereafter the hook fasteners 50 may be mated to the loop fasteners 52 to releasably secure the heat-resistant panel 36 to cover the leg 16.

In this drawing, a first heat-resistant panel 36 is shown having snaps 51. As an alternative to using the straps 42 and buckles 46, the heat-resistant panel 36 may be wrapped around the leg 16 and the snaps 51 proximal to the first side edge 44 may be mated to the snaps 51 proximal to the second side edge 48 to releasably secure the heat-resistant panel 36 to cover the leg 16. Also, the snaps 51 may be mated to snaps disposed on pants, chaps, shorts or other clothing covering a person's lower body to releasably secure the heat-resistant panel 36 to clothing.

In this drawing, a second heat-resistant panel 36 is shown having buttons 53 and button holes 55. As an alternative to using the straps 42 and buckles 46, the heat-resistant panel 36 may be wrapped around the leg 16 and the buttons 53 may be inserted through the button holes 55 to releasably secure the heat-resistant panel 36 to the leg 16. Also, the buttons 53 and button holes 55 may be mated to buttons and button holes disposed on pants, chaps, shorts or other clothing covering a person's lower body to releasably secure the heat-resistant panel 36 to clothing.

One of ordinary skill in the art will recognize that straps, hook fasteners, loop fasteners, buckles, snaps, buttons and button holes are examples of any number of articles or openings suitable for releasably securing the heat-resistant panels 36 over portions of a person's body or to clothing. One of ordinary skill in the art will recognize that buckles, snaps and buttons may be made of plastic, metal or any other suitable material. One of ordinary skill in the art will recognize that straps may be made of elastic, nylon, polychloroprene or any other suitable fabric or material.

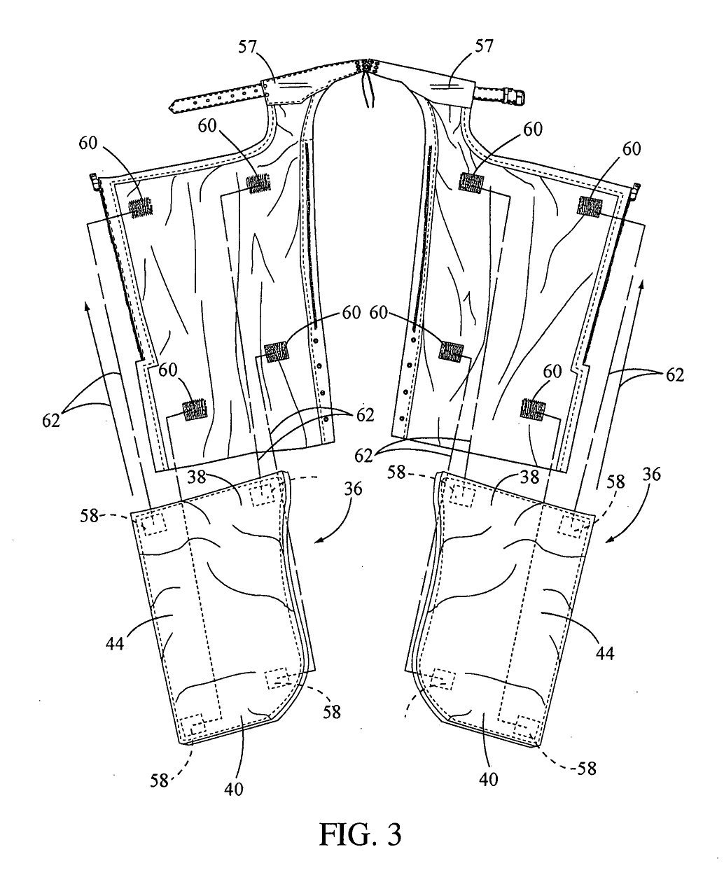

In FIG. 3, a front view of a pair of individual heat-resistant panels 36 and motorcycle chaps 56 with a waist belt 57 is presented. In this drawing, the heat-resistant panels 36 are adapted to be releasably secured to an inside surface 54 of the motorcycle chaps 56. Hook fasteners 58 are attached to the heat-resistant panels 36. Loop fasteners 60 are attached to the motorcycle chaps 56. The hook fasteners 58 may be mated to the loop fasteners 60, as indicated by arrows 62. While hook fasteners 58 and loop fasteners 60 are shown in this drawing, one of ordinary skill in the art will recognize that any straps, buckles, snaps, buttons and button holes are examples of any number of articles or openings suitable for releasably securing the heat-resistant panels 36 to the motorcycle chaps 56 without departing from the scope of the invention, as discussed above with respect to FIG. 2.

In FIG. 4, a partial sectional front view of the person 10 wearing the motorcycle chaps 56 with a pair of the heat-resistant panels 36 releasably secured to an inside surface 54 the motorcycle chaps 56, as described in detail with respect to FIG. 3, is presented. In this drawing, a portion of the motorcycle chaps 56 has been cutaway to illustrate one of the heat-resistant panels 36, wherein hook fasteners 58 attached to the heat-resistant panel 36 are mated to loop fasteners 60 attached to the chaps 56.

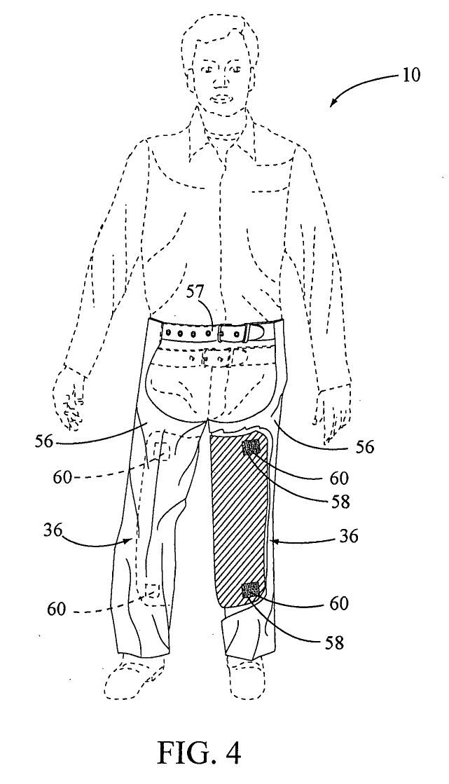

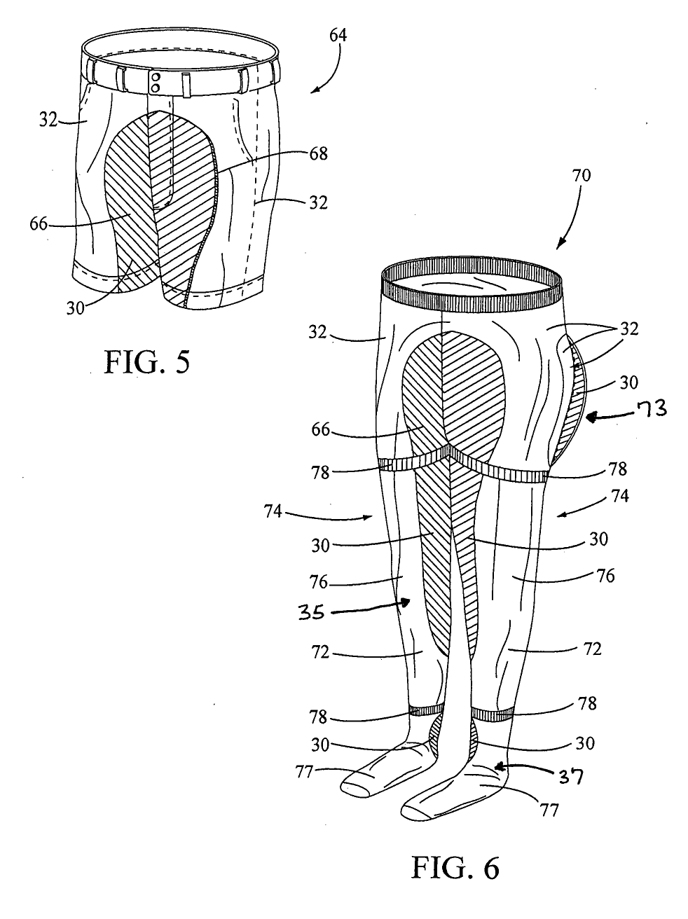

In FIG. 5, a perspective view of a pair of shorts having general reference numeral 64 and including a heat-resistant panel 30 and a pants member 32 is presented. The heat-resistant panel 30 is non-releasably attached to the pants member 32 and is dimensioned to cover a crotch area 66 of the shorts 64. In this example, an edge 68 of the panel 30 is stitched to sides of the pants member 32.

In FIG. 6, a perspective view of undergarment pants having a general reference numeral 70 and including a heat-resistant panel 30 and a pants member 32 is presented. The undergarment pants 70 may be worn alone or underneath or over other clothing. The heat-resistant panel 30 is non-releasably secured to the pants member 32 and is dimensioned to cover an undergarment pants crotch area 66, the inside of pants legs 72 and an undergarment pants seat area 73. In this drawing, a portion of the heat-resistant panel 30 is shown folded back prior to being non-releasably secured over a portion of the pants member 32.

Also in this drawing, the pants legs 72 may be converted to hose, having general reference numeral 74. The hose 74 may be releasably secured to the pants legs 72 and may extend downwardly from the undergarment pants crotch area 66 down to the person's ankle area 37 and include heat-resistant panels 30 along the inside of the hose legs 76. Also, the pants legs 72 can include heat-resistant panels 30 next to the rider's ankle areas 37 or individual socks 77 for protecting a person 10 from the heat of a motorcycle exhaust 21. Further, the pants legs 72 include heat-resistant panels 30 next to the rider's knee areas 35 for protection from the heat of the motorcycle exhaust 21. The hose 74 can include elastic bands 78 for holding the hose 74 tightly on the legs 16.

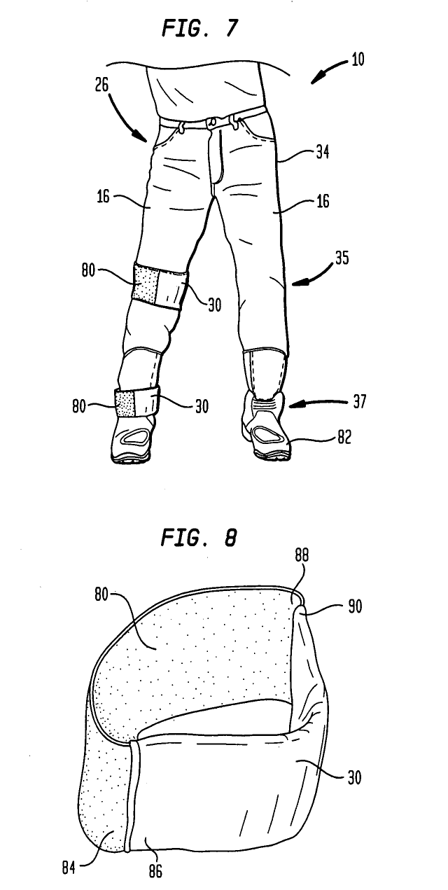

In FIG. 7, a front view of the lower body 26 of a person 10 is presented. The person 10 is shown wearing heat-resistant panels 30 that block heat generated by the engine 20 and exhaust 21 of a motorcycle 12 and that are dimensioned to cover the knee area 35 and ankle area 37. In this drawing, straps 80 are attached to the heat-resistant panels 30, and the heat-resistant panels 30 are releasably secured to the legs 16 of the person 10 over the knee area 35 of pants 34 and the ankle area 37 of a boot 82. Alternatively, the heat-resistant panels 30 may be releasably secured to the legs 16 of the person 10 and worn underneath pants 34 or inside boots 82. Alternatively, heat-resistant panels 30 without straps 80 may be releasably or non-releasably secured to inner surfaces 81 or outer surfaces 83 of pants 34 or boots 82 using buttons, snaps, buckles, button holes, stitching, adhesive or any other suitable articles or openings.

In FIG. 8, a perspective view of a heat-resistant panel 30 is presented. The heat-resistant panel 30 may be manufactured in different shapes and sizes. The heat-resistant panel 30 may be dimensioned to cover, for example, a knee area 35 or an ankle area 37. In this drawing, a first end 84 of a strap 80 is attached to a first side edge 86 of the heat-resistant panel 30, and a second end 88 of the strap 80 is attached to a second side edge 90 of the heat-resistant panel 30. Alternatively, a heat-resistant panel 30 without a strap 80 may feature buttons, snaps, buckles, button holes, stitching, adhesive or any other suitable articles or openings for releasably or non-releasably securing the heat-resistant panel 30 to a person 10 or to clothing. The heat-resistant panel 30 may be worn by a person 10 alone or underneath or over clothing or footwear.

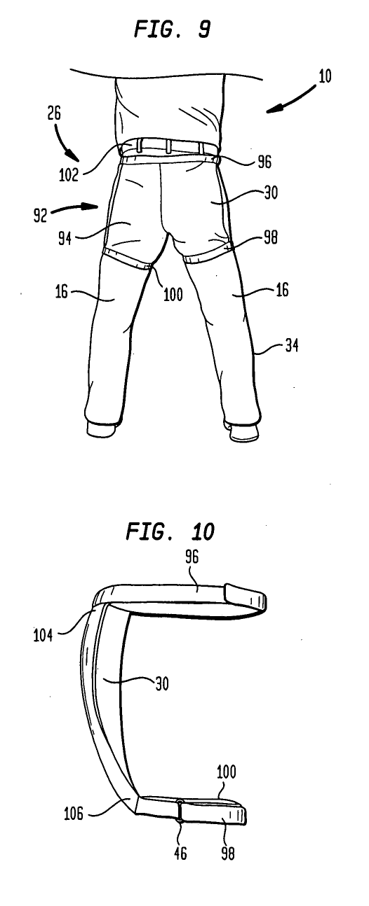

In FIG. 9, a rear view of the lower body 26 of a person 10 is presented. The person 10 is shown wearing a heat-resistant panel 30 that blocks heat generated by the engine 20 and exhaust 21 of a motorcycle 12 and that is dimensioned to cover the seat area 92, including posterior buttocks 94 and posterior upper portions of the legs 16. In this drawing, a first strap 96, second strap 98 and third strap 100 are attached to the heat-resistant panel 30 to releasably secure the heat-resistant panel around the waist 102 and legs 16 of the person. In this drawing, the heat-resistant panel 30 is worn over pants 34. Alternatively, the heat-resistant panel 30 may be worn as an undergarment. The heat-resistant panel 30 may be releasably or non-releasably secured to the person or to pants using straps, buttons, snaps, buckles, button holes, stitching, adhesive or any other suitable articles or openings. A heat-resistant panel 30 not secured to the person or to clothing may also be worn as an undergarment.

In FIG. 10, a side view of a heat-resistant panel 30 is presented. In this drawing, the heat-resistant panel 30 is dimensioned to cover a seat area 92 of a person 10. A first strap 96 is attached to a top edge 104 of the heat-resistant panel 30 and incorporates hook fasteners 50 and loop fasteners 52 to releasably secure the first strap 96 around the waist 102 of a person 10. A second strap 98 and third strap 100 are attached to bottom edges 106 of the heat-resistant panel 30 and incorporate buckles 46, hook fasteners 50 and loop fasteners 52 to releasably secure the second strap 98 and third strap 100 around the legs 16. The heat-resistant panel 30 in FIG. 10 may also be dimensioned to cover the crotch area 24 of a person or any combination of the crotch area 24, seat area 92 and legs 16.

In some embodiments, the heat-resistant panel 30 and the heat-resistant panels 36 comprise materials that provide thermal insulation. Suitable thermal insulating materials for use in some embodiments include polypropylene, polyester fibers, polyphenylene sulfide fibers, oxidized polyacrylonitrile fibers, meta-aramid fibers, para-aramid fibers, polytetrafluoroethylene fibers, polyimide fibers, polyparaphenylenebenzobisoxazole fibers, carbon fibers, inorganic fibers such as glass fibers and metallic fibers, polybenzimidazole fibers, modacrilic fibers, polyvinyl halide fibers, wool fibers, nylon fibers, rayon fibers, cotton fibers, ceramic wool fibers, melamine foam, urethane foam, rubber, polyethylene foam, polychloroprene, polyester foam and polyether polyurethane foam.

In some embodiments, the thermal insulating materials for use in the heat-resistant panel 30 and the heat-resistant panels 36 are woven fabrics, knitted fabrics, nonwoven fabrics, thread ply sewn fabrics or the like and may be incorporated in the heat-resistant panel 30 and the heat-resistant panels 36 by one of ordinary skill in the art in any suitable fashion.

In some embodiments, the thermal insulating materials for use in the heat-resistant panel 30 and the heat-resistant panels 36 are rubber, polychloroprene, foam, including open-cell and closed cell foam, or the like and may be incorporated in the heat-resistant panel 30 and the heat-resistant panels 36 by one of ordinary skill in the art in any suitable fashion.

In some embodiments, at least one component of the heat-resistant panel 30 and the heat-resistant panels 36 reflects radiant heat. In some embodiments, thermal reflectivity may be provided by materials with a reflective surface such as polyethylene terephthalate film coated with aluminum or other metals.

In some embodiments, the heat-resistant panel 30 and the heat-resistant panels 36 comprise polypropylene.

In some embodiments, the heat-resistant panel 30 and the heat-resistant panels 36 comprise polyester fibers (sold as POLY-FIL® by Fairfield Processing Corp.) needlepunched through a nonwoven substrate and through a reflective polyethylene terephthalate film (sold as MYLAR® by DuPont Teijin Films). The multi-component fabric provided for in these embodiments is sold as INSUL-BRIGHT® by The Warm Co.

In some embodiments, the heat-resistant panel 30 and the heat-resistant panels 36 provide heat resistance of from about 80% to about 100%. In some embodiments, the heat-resistant panel 30 and the heat-resistant panels 36 provide heat resistance of from about 85% to about 92%.

### EXAMPLE 1

The embodiment of the heat-resistant panels 36 as shown in FIG. 2 was tested on a stationary HARLEY-DAVIDSON® ROAD KING® motorcycle featuring a 1584 cubic centimeter engine. The heat-resistant panels 36 each incorporated two stacked layers of INSUL-BRIGHT®, providing total thickness of about 0.25 inches for each of the heat-resistant panels 36, and were worn over denim jeans by the motorcycle rider. The rider straddled the motorcycle in a standing position during the test. The motorcycle engine was turned on at T=0 minutes, and temperatures were measured on the inside surface and outside surface of one of the heat-resistant panels 36 at 0, 5 and 10 minutes using a non-contact infrared thermometer. The inside surface of the heat-resistant panel 36 was proximal to the motorcycle rider's leg and the outside surface of the heat-resistant panel 36 was proximal to the motor.

| | T = 0 min. | T = 5 min. | T = 10 min. |
|---|---|---|---|
| Inside surface of | 96° F. | 98° F. | 101° F. |
| panel | | | |
| Outside surface of | 96° F. | 142° F. | 160° F. |
| panel | | | |

At T=10 minutes, the temperature measured on the outside surface of the heat-resistant panel 36 was 160° F., and the temperature measured on the inside surface of the heat-resistant panel 36 was 101° F. At T=0 minutes, the temperature was 96° F. as measured at both the outside surface of the heat-resistant panel 36 and the inside surface of the heat-resistant panel 36. The heat resistance is determined as (160° F.−101° F.)/(160° F.−96° F.)×100%, yielding a heat resistance of about 92%.

### EXAMPLE 2

The embodiment of the heat-resistant panels 36 as shown in FIG. 3 was tested on a stationary HARLEY-DAVIDSON® ROAD KING® motorcycle featuring a 1584 cubic centimeter engine. The heat-resistant panels 36 each incorporated two stacked layers of INSUL-BRIGHT®, providing total thickness of about 0.25 inches for each of the heat-resistant panels 36, and were worn underneath leather motorcycle chaps by the motorcycle rider, as shown in FIG. 4. The rider straddled the motorcycle in a standing position at T=0 minutes. At T=0 minutes, the motorcycle engine had been in continuous operation for approximately 10 minutes. Temperatures were then measured on the inside surface of one of the heat-resistant panels 36 and the outside surface of the motorcycle chaps at 0 and 10 minutes using a non-contact infrared thermometer. The inside surface of the heat-resistant panel 36 was proximal to the motorcycle rider's leg and the outside surface of the motorcycle chaps was proximal to the motor.

| | T = 0 min. | T = 10 min. |
|---|---|---|
| Inside surface of | 94° F. | 87° F. |
| panel | | |
| Outside surface of | 94° F. | 150° F. |
| motorcycle chaps | | |

### EXAMPLE 3

Single plies of selected fabric materials were exposed to heat from a hair blowdryer. A photographic mat having a hole and having paper taped over the mat hole was placed in front of a fabric ply. The blowdryer was positioned in front of the photographic mat, and hot air from the blowdryer was applied to the photographic mat and the attached paper.

The temperature of each fabric ply was measured using a non-contact thermometer at selected points in time. The table below lists the materials tested in the left-hand column, the elapsed time in seconds for each temperature measurement in the top row and the temperature measurements in ° F. Where two fabrics were tested in combination, e.g. Nomex/Thermolite, the first-listed fabric was placed in between the photographic mat and the second-listed fabric.

| | 0 | 30 | 60 | 90 | 120 | 150 | 180 | 210 | 240 |
|---|---|---|---|---|---|---|---|---|---|
| Harrison 5502 | 74.8 | 98.4 | | | | | | | |
| mesh | | | | | | | | | |
| Polarfleece | 71.7 | 100.5 | 101 | | | | | | |
| Harrison 786 mesh | 72.6 | 102.9 | | | | | | | |
| Patagonia Wickaway | 69 | 105 | | | | | | | |
| Corning ironing | 70.5 | 104 | | | | | | | |
| board cover | | | | | | | | | |
| Nomex | 70.7 | 110 | | | | | | | |
| Nomex/Corning | 74 | 95 | 97 | 98 | 99 | 99 | 98.6 | 98 | 99 |
| ironing board | | | | | | | | | |
| cover | | | | | | | | | |
| Oven mitt holder | 68.7 | 74.8 | 78 | 80.4 | 80.7 | 84 | 84 | 85 | 86 |
| Zyflex | 72.3 | 98.4 | 101 | 102 | | | | | |
| Corning ironing | 74 | 96 | 99.6 | 99.5 | 100 | 100.4 | | 100 | 99.5 |
| board | | | | | | | | | |
| cover/Zyflex | | | | | | | | | |
| Paper | 64.5 | 101 | 103 | 103.8 | 104 | 104 | 104 | | |
| Motorcycle pants | 76.4 | 108 | 109 | 109 | 108 | | | | |
| Duofold | 73 | 109 | 110 | 112 | 111 | | | | |
| Corning ironing | 76.4 | 95 | 98 | 99.6 | 100.7 | 101.1 | 101.3 | 101.6 | 101.6 |
| board | | | | | | | | | |
| cover/Duofold | | | | | | | | | |
| Thermolite | 68.5 | 103.4 | 105.4 | 106 | 105 | 106 | 106.8 | 106.3 | 106.3 |
| Nomex/Thermolite | 72 | 91.7 | 94.6 | 94.6 | 95 | 96 | 95 | 96 | 96 |
| Nomex/Corning | 71 | 89 | 93 | 93.5 | 95 | 95 | 95.5 | 96 | 96 |
| ironing board | | | | | | | | | |
| cover | | | | | | | | | |

One of ordinary skill in the art will appreciate that some embodiments provide multiple plies of thermal insulating materials incorporated in the heat-resistant panel 30 and the heat-resistant panels 36. One of ordinary skill in the art will further appreciate that said incorporation of multiple plies of thermal insulating materials may provide increased thickness and increased heat resistance of the heat-resistant panel 30 and the heat-resistant panels 36. One of ordinary skill in the art will further appreciate that some embodiments provide the heat-resistant panel 30 and the heat-resistant panels 36 with thickness of from about 0.25 inches to about 0.75 inches.

In some embodiments, the heat-resistant panel 30 and the heat-resistant panels 36 maintain their shape after prolonged exposure to temperatures above 98° F.

In some embodiments, the heat-resistant panel 30 and the heat-resistant panels 36 have high tensile strength. In some embodiments, the heat-resistant panel 30 and the heat-resistant panels 36 maintain high tensile strength after prolonged exposure to temperatures above 98° F.

In some embodiments, the heat-resistant panel 30 and the heat-resistant panels 36 have high abrasion resistance. In some embodiments, the heat-resistant panel 30 and the heat-resistant panels 36 maintain high abrasion resistance after prolonged exposure to temperatures above 98° F.

In some embodiments, the heat-resistant panel 30 and the heat-resistant panels 36 are flexible. In some embodiments, the heat-resistant panel 30 and the heat-resistant panels 36 maintain flexibility after prolonged exposure to temperatures above 98° F.

In some embodiments, the pants member 32 comprises fabric materials. In some embodiments, the pants member 32 comprises nylon, polyester, cotton or other suitable lightweight, breathable fabric materials. In some embodiments, the pants member 32 provides heat resistance of less than about 80%.

In some embodiments, the heat-resistant panel 30 and the heat-resistant panels 36 are selectively dimensioned to cover certain portions of a person's lower body, including legs 16, knee areas 35, ankle areas 37, the seat area 92 and the crotch area 24 to provide protection from heat generated by an engine 20 and exhaust 21 while the pants member 32 is selectively dimensioned to cover the remaining portions of the person's lower body to provide light weight, breathability and heat dissipation, wherein the heat-resistant panel 30 and the heat-resistant panels 36 are releasably or non-releasably secured to the pants member 32.

In some embodiments, the pants 34 and motorcycle chaps 56 comprise materials that are abrasion-resistant and tear-resistant. In some embodiments, the pants 34 and motorcycle chaps 56 comprise nylon, leather or other suitable abrasion-resistant, tear-resistant materials.

The present invention further provides a method of blocking heat from an engine or exhaust of a motorized vehicle for the purpose of protecting a person operating or using the motorized vehicle by securing a heat-resistant panel to any portion of the person's body subject to or exposed to heat from an engine or exhaust. Alternatively, in the method described above, the heat-resistant panel may be secured to clothing worn by the person covering any portion of the person's body subject to or exposed to heat from an engine or exhaust. One of ordinary skill in the art will recognize that straps, hook fasteners, loop fasteners, buckles, snaps, buttons, adhesive, stitching and button holes are examples of any number of articles or openings suitable for securing the heat-resistant panel over portions of a person's body or to clothing. One of ordinary skill in the art will understand that the methods described herein enable a person to customize the location and extent of protection from heat generated by an engine or exhaust by altering the placement of a heat-resistant panel secured to a person or to clothing worn by the person. One of ordinary skill in the art will further understand that the adjustability of the location of a heat-resistant panel, as provided by the methods described herein, is particularly beneficial to a person who may operate different motorized vehicles having differing engine and exhaust configurations, such that the person may correspondingly desire heat protection provided by a heat-resistant panel over different portions of the person's body.

While the invention has been particularly shown, described and illustrated in detail with reference to embodiments and modifications thereof, it should be understood by those skilled in the art that equivalent changes in form and detail may be made therein without departing from the scope of the invention as claimed, except as precluded by the prior art.

What is claimed is:

1. A heat-resistant panel.

2. The heat-resistant panel of claim 1 wherein the heat-resistant panel is dimensioned to be placed between a person and heat from an engine or an exhaust of a motorized vehicle.

3. The heat-resistant panel of claim 1 wherein the heat-resistant panel is dimensioned to cover a leg area of a person.

4. The heat-resistant panel of claim 1 wherein the heat-resistant panel is dimensioned to cover an upper leg area of a person.

5. The heat-resistant panel of claim 1 wherein the heat-resistant panel is dimensioned to cover a lower leg area of a person.

6. The heat-resistant panel of claim 1 wherein the heat-resistant panel is dimensioned to cover a knee area of a person.

7. The heat-resistant panel of claim 1 wherein the heat-resistant panel is dimensioned to cover an ankle area of a person.

8. The heat-resistant panel of claim 1 wherein the heat-resistant panel is dimensioned to cover a seat area of a person.

9. The heat-resistant panel of claim 1 wherein the heat-resistant panel is dimensioned to cover a crotch area of a person.

10. The heat-resistant panel of claim 1 wherein the heat-resistant panel comprises thermal insulating material.

11. The heat-resistant panel of claim 1 wherein the heat-resistant panel comprises one or more materials selected from the group consisting of polypropylene, polyester fibers, polyphenylene sulfide fibers, oxidized polyacrylonitrile fibers, meta-aramid fibers, para-aramid fibers, polytetrafluoroethylene fibers, polyimide fibers, polyparaphenylenebenzobisoxazole fibers, carbon fibers, glass fibers, metallic fibers, polybenzimidazole fibers, modacrilic fibers, polyvinyl halide fibers, wool fibers, nylon fibers, rayon fibers, cotton fibers, ceramic wool fibers, melamine foam, urethane foam, rubber, polyethylene foam, polychloroprene, polyester foam, polyether polyurethane foam and polyethylene terephthalate film.

12. The heat-resistant panel of claim 1 wherein the heat-resistant panel comprises polyester fibers needlepunched through a nonwoven substrate and through a reflective polyethylene terephthalate film.

13. The heat-resistant panel of claim 1 wherein the heat-resistant panel provides heat resistance of from about 80% to about 100%.

14. The heat-resistant panel of claim 1 wherein the heat-resistant panel provides heat resistance of from about 85% to about 92%.

15. The heat-resistant panel of claim 1 wherein the heat-resistant panel provides heat resistance of from about 80% to about 100% after exposure to heat generated by a motorcycle engine continuously in operation for about 10 minutes.

16. The heat-resistant panel of claim 1 wherein the heat heat-resistant panel provides heat resistance of from about 85% to about 92% after exposure to heat generated by a motorcycle engine continuously in operation for about 10 minutes.

17. The heat-resistant panel of claim 1 wherein the heat-resistant panel has thickness of from about 0.25 inches to about 0.75 inches.

18. The heat-resistant panel of claim 1 wherein the heat-resistant panel is secured to a person.

19. The heat-resistant panel of claim 1 wherein the heat-resistant panel is releasably secured to a person.

20. The heat-resistant panel of claim 1 wherein the heat-resistant panel is secured to clothing.

21. The heat-resistant panel of claim 1 wherein the heat-resistant panel is releasably secured to clothing.

22. A method of blocking heat from an engine or an exhaust of a motorized vehicle comprising placing a heat-resistant panel between a person and the engine or exhaust.
